(19) United States
(12) Patent Application Publication
(10) Pub. No.: US 2024/0193968 A1
(43) Pub. Date: Jun. 13, 2024

(54) ANALYZING MICROSCOPE IMAGES OF MICROALGAE CULTURE SAMPLES

(71) Applicant: TOTALENERGIES ONETECH, Courbevoie (FR)

(72) Inventors: Thomas ELAN, Pau (FR); Ludivine ALLAIS, Pau (FR); Pierrick POCHELU, Pau (FR); Cecilia SAMBUSITI, Pau (FR); Myriam SAADOUNI, Pau (FR); Nicolas BARBARIN, Pau (FR); Michel BAHUAUD, Pau (FR); Bruno CONCHE, Pau (FR)

(21) Appl. No.: 18/286,896

(22) PCT Filed: Apr. 13, 2021
(86) PCT No.: PCT/IB2021/000279

§ 371 Date: Oct. 13, 2023

(51) Int. Cl. G06V 20/69; G06V 10/25; G06V 10/28; G06V 10/774; G06V 10/82

(52) U.S. Cl. CPC G06V 20/698; G06V 10/25; G06V 10/28; G06V 10/774; G06V 10/82; G06V 20/695

(57) ABSTRACT

The disclosure notably relates to methods, devices, programs and other data structures related to machine-learning an artificial neural network function configured for analyzing microscope images of microalgae culture samples with respect to one or more biological attributes. The one or more biological attributes comprise a category among a predetermined set of categories which includes a plurality of microalgae species and/or genera and at least one non-algae micro-organism category. The one or more biological attributes further comprise a physiological state among a predetermined set of microalgae physiological states. The artificial neural network function forms an improved solution for analyzing microalgae culture sample.

### TECHNICAL FIELD

The disclosure relates to the field of computer programs and systems, and more specifically to methods, devices, programs and other data structures related to machine-learning an artificial neural network (ANN) function configured for analyzing microscope images of microalgae culture samples.

### BACKGROUND

Microalgae are unicellular micro-organisms, usually found in marine or freshwater media. The size of microalgae can range from 1 to 100 micrometers.

The scientific literature recognizes five general classes: diatoms, green algae, brown algae, red algae and cyanobacteria. The biodiversity of microalgae is enormous and it has been estimated that there exists between two-hundred thousand and eight hundred thousand species among different genera or families.

Moreover, microalgae are phototrophic organisms, i.e., organisms that use visible light as an energy source for their metabolism via photosynthesis. The use of microalgae in industrial applications such as biological wastewater treatment systems and bioreactor systems has gained an increasing interest over the years. Microalgae are used in wastewater systems to capture carbon dioxide (CO2) in order to produce oxygen and carbon (including, e.g., carbohydrates, algae cells, lipids, etc.) via photosynthesis. Bacteria may use the produced oxygen present in the wastewater to oxidize ammonium into nitrate. Microalgae are used in bioreactor systems to uptake nutrients such as ammonium, nitrate and phosphate and produce biofuel or other value-added products.

The activity and health of populations of possibly multiple species microalgae present in wastewater or bioreactor systems depend on several factors, such as the intensity of light, weather conditions, pH, salinity and the interaction of the microalgae with other organisms, such as bacteria.

Monitoring of the activity and health of communities of microalgae in wastewater or bioreactor systems, makes it possible to determine the kinetic and stoichiometric parameters essential for describing the optimal conditions for their growth so as to optimize biological wastewater treatment or biomass production.

Bioreactor systems, for instance open pond systems, pose several challenges that make it difficult to monitor the health of communities of microalgae. Open ponds are widely used in industrial production of biomass culture for biofuels production. The open ponds may be of different sizes and forms, such as artificial pond, basins, natural lakes, or raceways.

On the one hand, open ponds are easy to set up and to operate, thanks to their basic and artisanal process of construction and maintenance. Moreover, open ponds have low energy consumption, thus lower operating expenses, compared to closed systems.

On the other hand, open ponds are subject to multiple environmental factors that may affect the health of microalgae population, due to the large surface exposed to the environment. For example, their large surface allows other organisms to grow in the pond (due to exchange with atmosphere) and it could lead to competition with the microalgae culture for obtaining resources. It may further result on other species taking over the microalgae culture and developing instead of the intended culture. Moreover, the microalgae culture is affected by sun-light intensity throughout the day, the sun-light incidence of the region where the open pond is located, and the light intensity corresponding to the season of the year. Microalgae may also be affected by exposure to atmospheric CO2, or changes in the weather conditions. Another factor impacting the health of microalgae population is the evaporation rate of the open pond, where water levels must be regularly adjusted. If the factors impacting the microalgae culture are not mitigated, this might lead to a culture crash, which creates inconveniences to the productivity of the bioreactor.

Thus, microalgal population within a bioreactor system must be analyzed regularly, by taking microalgae culture samples from the bioreactor system and analyzing the samples. This is currently performed using high-throughput sequencing methods or qPCR (quantitative Polymerase Chain Reaction) for detecting eukaryotic and prokaryotic populations present within the culture. The monitoring allows to make qualitative assertions concerning the nature of algae (species within a family or genus) and their state of health (cell under stress, cell in good health, presence of microbial contamination, etc.).

Existing methods of quantification by qPCR are described in the following publications:
Bacterial 16S (total bacteria): Yu, Youngseob, Changsoo Lee, Jaai Kim, et Seokhwan Hwang. 2005. «Group-Specific Primer and Probe Sets to Detect Methanogenic Communities Using Quantitative Real-Time Polymerase Chain Reaction». Biotechnology and Bioengineering 89 (6): 670-79. https://doi.org/10.1002/bit.20347.
18S eukaryotes (total eukaryotes): Lakaniemi, Aino-Maija, Chris J. Hulatt, Kathryn D. Wakeman, David N. Thomas, et Jaakko A. Puhakka. 2012. «Eukaryotic And Prokaryotic Microbial Communities During Microalgal Biomass Production». Bioresource Technology 124 (November): 387-93. https://doi.org/10.1016/j.biortech.2012.08.048.
Existing methods of quantification by high-throughput sequencing are described in the following publications:
Bacterial 16S: Parada, Alma E., David M. Needham, et Jed A. Fuhrman. 2016. «Every Base Matters: Assessing Small Subunit RRNA Primers For Marine Microbiomes With Mock Communities, Time Series And Global Field Samples». Environmental Microbiology 18 (5): 1403-14. https://doi.org/10.1111/1462-2920.13023.o Eukaryotic 18S: (Bradley et al., 2016)
23S specific to algae and cyanobacteria plastids: Sherwood, Alison R., et Gernot G. Presting. 2007. «Universal Primers Amplify A 23s Rdna Plastid Marker In Eukaryotic Algae And Cyanobacterial». Journal of Phycology 43 (3): 605-8. https://doi.org/10.1111/j.1529-8817.2007.00341.x.

However, these methods are characterized by long waiting times for obtaining results (typically six months) so that a regular monitoring with these methods is impractical, notably in view of varying weather conditions (e.g., changes of temperature within a few days).

Within this context, there is still a need for an improved method for analyzing a microalgae culture sample.

### SUMMARY

It is therefore provided a computer-implemented method of machine-learning an artificial neural network (ANN) function configured for analyzing microscope images of microalgae culture samples. The artificial neural network analyzes the microscopic images with respect to one or more biological attributes. The one or more biological attributes comprises a category among a predetermined set of categories. The predetermined set of categories includes a plurality of microalgae species and/or genera and at least one non-algae micro-organism category. The one or more biological attributes further comprise a physiological state among a predetermined set of microalgae physiological states.

The machine-learning method comprises providing a dataset comprising training patterns. Each training pattern comprises a microscope image of a microalgae culture sample and a plurality of annotations. Each annotation comprises a localization in the image containing at least one given micro-organism. Each annotation further comprises a value of the one or more biological attributes for the at least one given micro-organism.

The machine-learning method also comprises training the ANN function based on the provided dataset. The ANN function is configured for processing an input microscope image of a microalgae culture sample. The ANN function computes, for each respective localization among a plurality of localizations in the image each containing at least one respective micro-organism, a respective output. The respective output represents a value of the one or more biological attributes for the at least one respective micro-organism.

In examples, the predetermined set of microalgae physiological states may include one or more microalgae health states.

In examples, the predetermined set of microalgae physiological states may include an agglomeration state and/or a duplication state.

In examples, the plurality of microalgae species and/or genera may include one or more species and/or genera from the following families: Chlorophyceae, Xanthophyceae, Chrysophyceae, Bacillariophyceae, Cryptophyceae, Dinophyceae, Chloromonadineae, Euglenineae, Phaeophyceae, Rhodophyceae, and/or Cyanophyceae.

In examples, the providing of the dataset may comprise, for each training pattern,-capturing the microscope image. Also, providing the dataset may comprise pre-processing the captured microscope image by one or both of a color balancing of the image and a contrast enhancement.

In examples, the providing of the dataset may comprise, for each training pattern, determining the localizations of the annotations. For example, the determination may be performed deterministically, such as with a region of interest algorithm.

In examples, the region of interest algorithm may comprise, for the microscope image of each training pattern, applying a low pass filter that outputs a binary image. Pixels of the binary image having value 0 correspond to pixels of the background and pixels of the binary image having value 1 correspond to a pixel of each microalgae of the culture. The region of interest algorithm may then comprise detecting connected components in the binary image. The region of interest algorithm may then comprise, for each connected component, determining a bounding box.

In examples, the artificial neural network function may comprise a binary classifier. The binary classifier may be configured, for each respective localization, to determine whether the at least one respective micro-organism is a microalgae or a non-algae micro-organism.

In examples, the artificial neural network function may comprise a multi-class classifier. The multi-class classifier may be configured, for each respective localization containing a microalgae micro-organism, to determine a respective class from a predetermined set of classes comprising combinations of both a microalgae species or genus and a physiological state.

In examples, the artificial neural network function may comprise a pre-processing. The pre-processing may be applied to the microscope image. The pre-processing may include one or both of a color balancing of the image and a contrast enhancement.

In examples, the artificial neural network function may comprise a deterministic sub-function configured for determination of the plurality of localizations. For example, the deterministic sub-function may be a region of interest detection algorithm.

In examples, the region of interest algorithm may comprise, for the input microscope image, applying a low pass filter that outputs a binary image. Pixels of the binary image having value 0 correspond to pixels of the background and pixels of the binary image having value 1 correspond to pixels of microalgae and non-algae micro-organisms of the culture. The region of interest algorithm may then detect connected components in the binary image. The region of interest algorithm may also, for each connected component, determine a bounding box.

In examples, the artificial neural network function may comprise an object detection neural network. The object detection neural network may be configured for determination of the plurality of localizations.

It is further provided a computer-implemented method for analyzing a microscope image of a microalgae culture sample. The image-analyzing method comprises providing an artificial neural network function trained according to the machine-learning method. The image-analyzing method comprises inputting to the artificial neural network function a microscope image of a microalgae culture sample. The image-analyzing method computes, for each respective localization among a plurality of localizations in the image each containing at least one respective micro-organism, a respective output. The output represents a value of the one or more biological attributes for the at least one respective micro-organism.

It is further provided a computer-implemented method for forming a dataset configured for machine-learning an ANN function with the machine-learning method. The dataset-forming method comprises providing microscope images for each of a microalgae culture sample. Also, for each microscope image, the dataset-forming method determines a plurality of annotations. Each annotation comprises a localization in the image containing at least one given micro-organism. Each annotation further comprises a value ofthe one or more biological attributes.

In examples, the providing of the microscope images may comprise, for each microscope image, capturing the microscope image. Also, the providing of the microscope image may pre-process the captured microscope image. The pre-processing may be performed by one or both of a color balancing of the image and a contrast enhancement.

In examples, the determining of the plurality of annotations may comprise, for each microscope image, determining the localizations of the annotations with a region of interest algorithm.

In examples, the region of interest algorithm may comprise for each microscope image applying a low pass filter that outputs a binary image. Pixels of the binary image having value 0 correspond to pixels of the background and pixels of the binary image having value 1 correspond to a pixel of each microalgae of the culture. Also, the region of interest algorithm may detect connected components in the binary image. Also, the region of interest algorithm may, for each connected component, determining a bounding box.

It is further provided a data structure comprising a computer program. The computer program includes instructions for performing the machine-learning method, the image-analyzing method and/or the dataset-forming method. The data structure may additionally or alternatively include a neural network function trained according to the machine-learning method. The data structure may additionally or alternatively include may also include a dataset formed according to the dataset-forming method.

It is further provided a device comprising a computer-readable medium having stored thereon the data structure.

In examples, the device further may comprise a processor coupled to the computer-readable medium.

### BRIEF DESCRIPTION OF THE DRAWINGS

Non-limiting examples will now be described in reference to the accompanying drawings, where:

FIGS. 1 to 3 shows flowcharts of examples of the provided methods;

FIG. 4 shows an example of the computer system;

FIG. 5 shows an example of a bioreactor;

FIGS. 6A and 6B show an example of an image acquired from a microscope and image processing thereof;

FIGS. 7A and 7b show an example of an image and contrast enhancement thereof;

FIG. 8 shows an example of annotation of training samples;

FIG. 9 shows an example of part of an ANN function;

FIG. 10 shows an example of performance metrics for training the ANN function;

FIG. 11 shows an example of an image analyzed with the trained ANN function;

FIGS. 12A and 12B show an example of annotation of training samples based on multiple microalgae genera;

FIG. 13 shows an example of performance metrics for training an object detection neural network;

FIG. 14 shows an example of training the ANN function using an Intersection-Over-Union constraint; and

FIG. 15 shows an example of a web application utilizing the ANN function and used for image analysis.

### DETAILED DESCRIPTION OF THE INVENTION

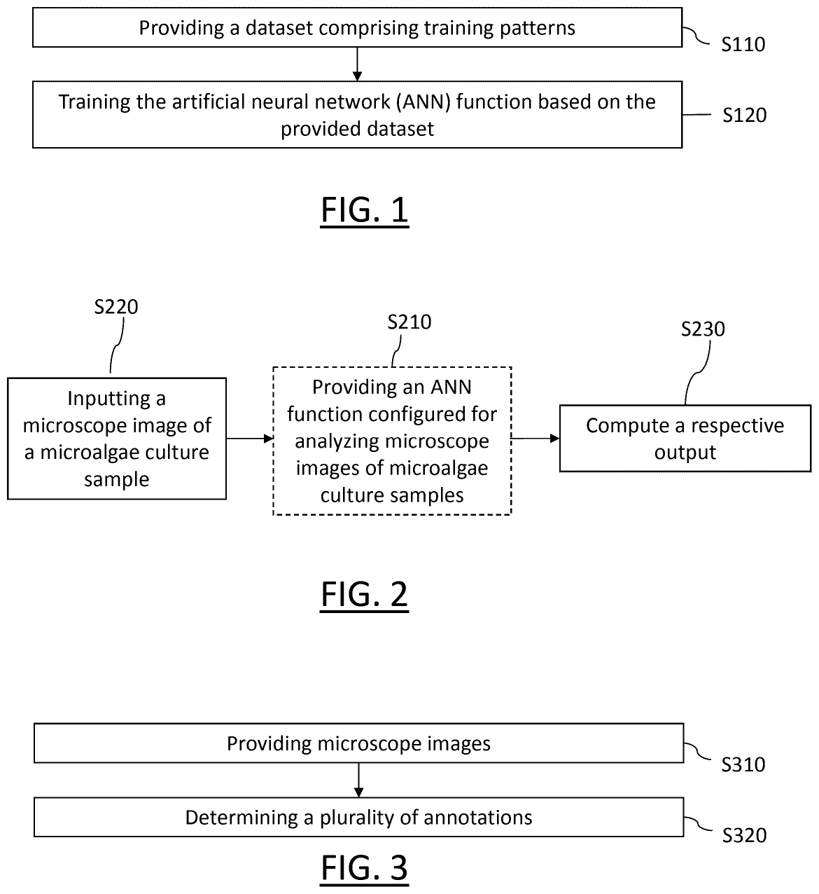

With reference to the flowchart of FIG. 1, it is proposed a computer-implemented method of machine-learning an artificial neural network (ANN) function. The ANN function is configured for analyzing microscope images of microalgae culture samples with respect to one or more biological attributes. The one or more biological attributes comprise a category among a predetermined set of categories. The predetermined set of categories includes a plurality of microalgae species and/or genera and at least one non-algae micro-organism category. The one or more biological attributes further comprise a physiological state among a predetermined set of microalgae physiological states.

The computer-implemented method of FIG. 1, also referred to as “the machine-learning method”, comprises providing S110 a dataset comprising training patterns. Each training pattern comprises a microscope image of a microalgae culture sample and a plurality of annotations. Each annotation comprises a localization in the image containing at least one given micro-organism. Each annotation further comprises a value of the one or more biological attributes for the at least one given micro-organism.

The machine-learning method then comprises training S120 the ANN function based on the provided dataset. The ANN function is configured for processing an input microscope image of a microalgae culture sample. The ANN function computes, for each respective localization among a plurality of localizations in the image each containing at least one respective micro-organism, a respective output. The respective output represents a value of the one or more biological attributes for the at least one respective micro-organism.

With reference to FIG. 2, it is further provided a computer-implemented method for analyzing a microscope image of a microalgae culture sample, using the ANN function. The method of FIG. 2 is also referred to as “the image-analyzing method”.

The image-analyzing method comprises providing S210 an artificial neural network function trained according to the machine-learning method. The image-analyzing method also comprises inputting S220 to the artificial neural network function a microscope image of a microalgae culture sample. The artificial neural network computes S230, for each respective localization among a plurality of localizations in the image, each containing at least one respective micro-organism, a respective output. The respective output represents a value of the one or more biological attributes for the at least one respective micro-organism.

The methods form improved solutions for analyzing a microalgae culture sample.

The methods propose an application of the machine-learning paradigm to analysis of microalgae culture samples, thus allowing automatic, substantially real-time (e.g., in less than an hour, ten minutes or even a minute) and accurate analysis. In order to do that, the methods identify that microalgae culture samples can efficiently and accurately be analyzed via microscope images thereof, so as to enable implementation of image-based machine-learning solutions. Since such solutions have long been developed, the ANN function architecture and the training may easily and robustly be implemented.

In addition, the ANN function provides particularly relevant information regarding an analyzed microalgae culture sample. In specific, the ANN function detects at least not only micro-organisms of different microalgae species and/or genera and non-algae micro-organisms present in the image, but also physiological states of detected microalgae micro-organisms. This allows determining at once not only whether the analyzed microalgae culture sample is contaminated or not, but also physiological condition of the microalgae. It has been identified that distinction between different microalgae species and/or genera, identification of non-algae micro-organisms, and identification of physiological states are attributes that may efficiently be measured via image-based machine-learning. These attributes indeed yield different visual patterns in microscope images, such patterns appearing to be recognizable by trained neural networks, such as the ANN function.

Moreover, the results are localized with respect to the microscope image, thus allowing ergonomic and robust verification thereof, as well as visual identification of numbers of micro-organisms (e.g., growth of cultures and/or proliferation of contaminating micro-organisms). In examples, the image-analyzing method may comprise displaying a graphical representation of the input microscope image augmented by graphical representations of the localizations (e.g., bounding boxes) and aside each localization representation a respective graphical representation of the corresponding output (e.g., textual information depicting the value of the one or more biological attributes for said localization). By “aside”, it is meant that each value representation is displayed closer to its respective localization representation than to other localization representations, thus allowing visually associating non-equivocally the graphical representations together.

Furthermore, the image-analyzing method may comprise capturing/shooting the microscope image using standard laboratory equipment and under standard laboratory conditions. Such acquisition may thus be particularly fast. The image-analyzing method may comprise inputting the microscope image directly (i.e., with no further processing after taking the shot) to the ANN function for processing, or after performing a pre-processing on the fly (i.e., with relatively short processing time, e.g., less than an hour or ten minutes), for example to enhance the quality of the image prior to the processing. Also, the ANN function may be configured to process any microscope image containing at least one respective micro-organism (e.g., possibly a community) and to compute a respective output for each respective micro-organism. The processing may be relatively fast, thus allowing to obtain information on the biological attributes of the micro-organisms on demand.

The image-analyzing method may be part of a maintenance process of an installation including at least one culture of microalgae. The installation may for example be a bioreactor (e.g., performing industrial production of biomass culture for biofuels production) or a biological wastewater treatment system. In examples, the installation may present an open pond configuration (e.g., open pond bioreactor). In examples, the culture of microalgae may occupy a zone presenting an area above 100 m×100 m.

The maintenance process comprises taking one or more samples of the microalgae culture from the installation (e.g., at different locations, for example at more than ten or twenty locations, and/or at different times, for example at a frequency higher than every week and/or for a duration higher than two months). The maintenance process further comprises obtaining (e.g., capturing/shooting) at least one respective microscope image from each of the one or more samples. The maintenance process then comprises inputting at least one (e.g., several, for example each) image to the (trained) ANN function so as to perform the image-analyzing method, thereby outputting a respective output for each inputted image. The maintenance process may further comprise performing one or more (feedback) actions on the installation based on the result of the respective output of the ANN function. For example, the process may comprise stirring the culture (for example if the output informs that the culture is agglomerated). Additionally or alternatively, the process may comprise supplying air and/or CO2 to the culture (for example if the output informs that the culture is lacking respectively air and/or CO2). Additionally or alternatively, the process may comprise removing and/or replacing part of the culture (for example if the output informs that it is contaminated by non-algae micro-organisms beyond a repairability threshold), for instance replacement by a new culture of the same species or genus.

The process may comprise performing the feedback actions on the bioreactor upon assessment by a user of the result of the respective output of the ANN function, or with at least some degree of automation that compares the outputs with a reference. For example, the system may count a ratio of healthy algae over unhealthy algae and/or a ratio of algae with respect to bacteria and compare it to a reference ratio. The bioreactor process may thus perform fully automatic feedback actions on the bioreactor to maintain the respective output close to the reference, like stirring the bioreactor. The degree of human intervention may be established according to the desired level of automatism.

The methods thus allow optimizing productivity of the installation (e.g., bioreactor). Due to the contamination, the algae may be dominated by other species, such as bacteria or cyanobacteria or other organisms, thereby yielding to a culture crash. The methods allow to maintain productivity and anticipate a culture crash due to the contamination. This is particularly useful for open pond bioreactors, which may be regularly contaminated by external elements, such as spores.

The result of the output of the ANN function is relatively fast compared to performing a manual analysis of the image, thanks to the automation achieved by the provided ANN function, which is trained according to the machine-learning method. This automation improves reaction time to perform the actions on the bioreactor, thereby improving industrial productivity of the bioreactor.

With reference to FIG. 3, it is also provided a computer-implemented method for forming a dataset (of training patterns) configured for machine-learning an ANN function with the machine-learning method and/or the image-analyzing method. The method is also referred to as “the dataset forming method”.

The dataset-forming method comprises providing S310 microscope images each of a microalgae culture sample. The providing at step S310 may comprise acquiring images with a microscope, and/or retrieving images acquired by a microscope. The providing S310 may further comprise pre-processing the acquired raw images. The method then comprises, for each microscope image, determining S320 a plurality of annotations. Each annotation comprises a localization in the image containing at least one given micro-organism. Each annotation further comprises a value of the one or more biological attributes. The determination S320 may comprise manual methods for creating annotations. The determination S320 may further comprise automatic processes, such as for determining the localizations of the annotations. In examples, the determining S320 may include any association between the annotations and the microscopic image, thereby forming a training pattern, for example, an association in a data structure such as a list of tuples.

The machine-learning method may comprise, in step S110, providing the dataset formed by the dataset-forming method. The provided dataset may have been formed, with the dataset-forming method, at different times, at different locations, with different systems and/or by different persons or entities.

The machine-learning method, the image-analyzing method and the dataset-forming method are computer-implemented. This means that steps (or substantially all the steps) of the methods are executed by at least one computer, or any system alike. Thus, steps of any of the methods are performed by the computer, possibly fully automatically, or, semi-automatically. In examples, the triggering of at least some of the steps of any of the methods may be performed through user-computer interaction. The level of user-computer interaction required may depend on the level of automatism foreseen and put in balance with the need to implement user's wishes. In examples, this level may be user-defined and/or pre-defined.

A typical example of computer-implementation of any of the methods is to perform said methods with a system adapted for this purpose. The system may comprise a processor coupled to a memory and a graphical user interface (GUI), the memory having recorded thereon a computer program comprising instructions for performing any of the methods. The memory may also store a dataset formed by the dataset-forming method. The memory is any hardware adapted for such storage, possibly comprising several physical distinct parts (e.g. one for the program, and possibly one for the dataset).

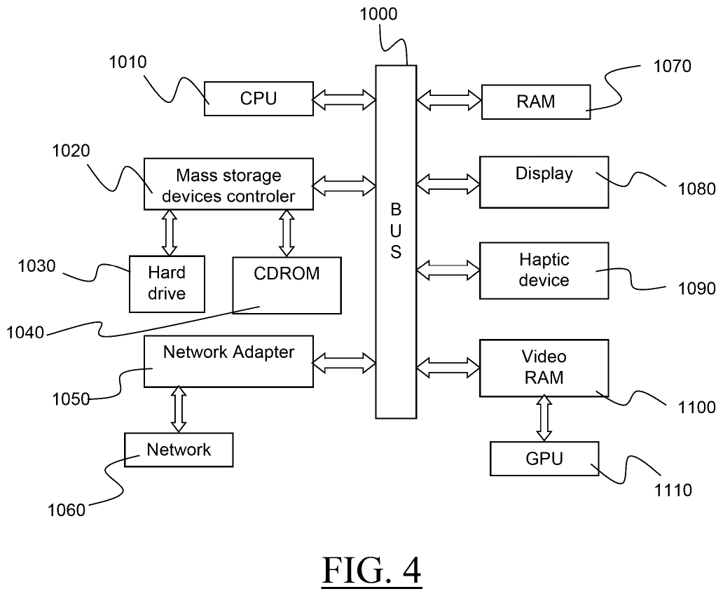

FIG. 4 shows an example of the system, wherein the system is a client computer system, e.g. a workstation of a user.

The client computer of the example comprises a central processing unit (CPU) 1010 connected to an internal communication BUS 1000, a random access memory (RAM) 1070 also connected to the BUS. The client computer is further provided with a graphical processing unit (GPU) 1110 which is associated with a video random access memory 1100 connected to the BUS. Video RAM 1100 is also known in the art as frame buffer. A mass storage device controller 1020 manages accesses to a mass memory device, such as hard drive 1030. Mass memory devices suitable for tangibly embodying computer program instructions and data include all forms of nonvolatile memory, including byway of example semiconductor memory devices, such as EPROM, EEPROM, and flash memory devices; magnetic disks such as internal hard disks and removable disks; magneto-optical disks; and CD-ROM disks 1040. Any of the foregoing may be supplemented by, or incorporated in, specially designed ASICs (application-specific integrated circuits). A network adapter 1050 manages accesses to a network 1060. The client computer may also include a haptic device 1090 such as cursor control device, a keyboard or the like. A cursor control device is used in the client computer to permit the user to selectively position a cursor at any desired location on display 1080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or a sensitive screen.

The computer program may comprise instructions executable by a computer, the instructions comprising means for causing the above system to perform any of the methods. The program may be recordable on any data storage medium, including the memory of the system. The program may for example be implemented in digital electronic circuitry, or in computer hardware, firmware, software, or in combinations of them. The program may be implemented as an apparatus, for example a product tangibly embodied in a machine-readable storage device for execution by a programmable processor. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device. The application program may be implemented in a high-level procedural or object-oriented programming language, or in assembly or machine language if desired. In any case, the language may be a compiled or interpreted language. The program may be a full installation program or an update program. Application of the program on the system results in any case in instructions for performing any of the methods.

Aspects of the machine-learning method are further discussed.

As known per se from the field of machine-learning, an artificial neural network (ANN) function is a function comprising one or more neural networks. In the case of the methods, the ANN function is configured to be provided with an input microscope image of a microalgae culture sample and to output values of the one or more biological attributes associated to localizations in the input image. Thus, the ANN function allows to augment the input microscope image with such biological attribute information. The ANN function may for example consist of a composition between one or more deterministic functions and one or more neural networks.

A neural network is a function comprising a collection of connected nodes, also called “neurons”. Each artificial neuron receives an input and outputs a result to other neurons connected to it. The artificial neurons and the connections linking each of them have weights, which are adjusted via a training. “Trainingthe ANN function” means training at least one neural network of the function. The input microscope image may be provided raw (i.e., as acquired) to the function, or alternatively after having been processed. The function itself may comprise a pre-processing sub-function, as detailed later.

At least one (e.g., each) neural network of the ANN function may comprise, for example, a convolutional neural network. Convolutional neural networks allow accurate image-processing. The methods have been successfully tested with the following convolutional neural network architectures known from the literature: InceptionV3, ResNet50, GoogleNet, YoloV5. The ANN function may optionally comprise non-neural network functions, such as deterministic functions.

At S120, the machine-learning method comprises training at least one (e.g., each) neural network of the ANN function. The machine-learning method may comprise adjusting all the weights of all the one or more neural networks. Optionally, the ANN function may comprise one or more pre-trained neural networks, and the machine-learning method may only adjust the weights of the untrained neural networks.

The ANN function is configured for analyzing microscope images of microalgae culture samples with respect to one or more biological attributes. By “analyzing” it is meant that the ANN function is configured to compute, from a given input microscope image of a microalgae culture sample, a respective output providing information relative to the one or more biological attributes.

By “biological attribute” it is meant any variable having values each forming a piece of information indicative of a biological characteristic of at least one micro-organism. Each biological attribute may be related to a biological characteristic of an individual micro-organism, or a biological characteristic of the organism in interaction with its medium and/or with other micro-organisms.

The one or more biological attributes comprise a first biological attribute which is a category among a predetermined set of categories that includes a plurality of microalgae species and/or genera and at least one non-algae micro-organism category. In other words, said first biological attribute takes values in said predetermined set of categories. Yet in other words, a value of said first biological attribute outputted by the ANN function may be any element of said predetermined set of categories, that is, any category of said predetermined set (i.e., any one of the microalgae species and/or genus or any one of the at least one non-algae micro-organism category).

Optionally, the plurality of microalgae species and/or genera may comprise at least one genus category, and for example consist of a plurality of microalgae genera (i.e., no microalgae species category in the predetermined set of categories). Microalgae of a same genus and yet of different species may present similarvisual characteristics. The ANN function may thus be trained to recognize microalgae genera rather than microalgae species. Alternatively, the plurality of microalgae species and/or genera may consist of a plurality of microalgae species (i.e., no microalgae genus in the predetermined set of categories).

The one or more biological attributes further comprise a second biological attribute which is a physiological state among a predetermined set of microalgae physiological states. In other words, said second biological attribute takes values in said predetermined set of physiological states. Yet in other words, a value of said second biological attribute outputted by the ANN function may be any element of said predetermined set of physiological states, that is, any physiological state of said predetermined set (e.g., any state among the union of the optional one or more microalgae health states, the optional agglomeration state, and/or the optional duplication state).

The ANN function thus computes for each respective localization (e.g., bounding box represented by coordinates (x,y) and size, such as width and height) among a plurality of localizations in the image, each respective localization containing at least one respective micro-organism, a respective output representing a value of the one or more biological attributes for the at least one respective micro-organism. In other words, for localizations each containing at least one micro-organism, the ANN function measures the one or more biological attributes of the at least one respective micro-organism of each such localization. The ANN function may provide each outputted value of the one or more biological attributes in the form of one or more labels.

The ANN function may further compute the localizations. The ANN function may compute the localizations via a deterministic function, or alternatively via a neural network. Details are provided alter.

It is understood that when a biological attribute does not apply to the type of the at least one micro-organism, the ANN function may output no value for said biological attribute, or equivalently, a null value. For example, when a localization contains a non-algae micro-organism (i.e., the outputted value of the first biological attribute thus being one among the at least one non-algae micro-organism category), the ANN function outputs no microalgae physiological state or a null value (i.e., no specific value of the second biological attribute, as this applies to microalgae only).

The ANN function may be configured to output at most one value per localization and per biological attribute. Alternatively, the ANN function may be configured to output several values per localization and per biological attribute. This may for example mean that several types of micro-organisms are present in said localization. Alternatively, the ANN function may be configured to output a distribution of probabilities overthe domain of values of at least one biological attribute, that is, several values of the at least one biological attribute each associated with a probability.

The predetermined set of categories may be predetermined according to industrial specifications of the micro-organisms present in the microalgae culture sample. The predetermined set of categories includes a plurality of microalgae species and/or genera and at least one non-algae micro-organism category.

In examples, the plurality of microalgae species and/or genera may include one or more species and/or genera from the families Chlorophyceae, Xanthophyceae, Chrysophyceae, Bacillariophyceae, Cryptophyceae, Dinophyceae, Chloromonadineae, Euglenineae, Phaeophyceae, Rhodophyceae, and/or Cyanophyceae. Alternatively or additionally, the plurality of microalgae species and/or genera may include one or more species of the genera Tetraselmis, Nannochloropsis, Dunaliella, and/or Chorella, and/or one or more of these genera The ANN function thus determines a classification of microalgae organisms in the microscope image with respect to any preferred taxonomical classification consisting of any combination of the above.

By “at least one non-algae micro-organism category”, it is meant that the predetermined set of categories comprises at least one category of micro-organisms including no microalgae. The at least one non-algae micro-organism category may consist of one single category grouping any kind of localized non-algae micro-organism, without further information on the type of micro-organism, e.g., a category “Other”. Alternatively, the at least one non-algae micro-organism category may comprise one or more non-microalgae species and/or genera and/or one or more non-microalgae families. Thus, the classification distinguishes the non-algae micro-organisms and may thereby indirectly allow for an improved assessment of the health of the microalgae.

A trained ANN function may process an input microscope image and output the non-algae micro-organisms species present in the culture, from which it may be determined the quantity and type of said non-algae micro-organisms. Thus, the machine-learning method yet improves the classification of the micro-organisms, as the classification provides quantitative assessments on the presence of micro-organisms which have different roles in the health of the microalgae.

For example, the one or more non-microalgae species and/or genera and/or one or more non-microalgae families may comprise one or more bacteria species and/or genera and/or one or more bacteria families. In examples, the bacteria may be native to the aqueous medium of the microalgae culture sample, and thus their presence may be beneficial to enhance microalgal growth by increasing the quantity of CO2 in the water so that the population of microalgae thrives in the bioreactor. This is the case, for instance, of autotrophic bacteria, such as ammonia oxidizing bacteria (bacteria oxidizing ammonia to nitrite) and/or nitrite-oxidizing bacteria (bacteria oxidizing nitrite to nitrate). In other examples, the bacteria or other micro-organisms may have been brought in via an external environmental factor and thus their presence may be undesirable. Thus, an uncontrolled population of bacteria present in the microalgae culture may lead to competition with the microalgae to obtain sufficient light and/or minerals resources.

Additionally or alternatively, the one or more non-microalgae species and/or genera and/or the one or more non-microalgae families may comprise one or more fungus species and/or genera and/or one or more fungi families.

Therefore, the ANN function trained according to machine-learning method detects not only micro-organisms of different microalgae species and/or genera but also improves the determination of non-algae micro-organisms present in the image. That is, the ANN function is more accurate to determine at least non-algae micro-organisms that interact with the microorganisms of different microalgae species. In turn, an intervention may be performed to the bioreactor to improve the health of the species of microalgae, or to inhibit the growth of other micro-organisms.

The one or more biological attributes further comprise a physiological state among a predetermined set of microalgae physiological states. Therefore, the machine-learning function enhances the classification of the micro-organisms beyond a taxonomical classification, to a classification according to the functioning of the micro-organisms in their medium. In turn, the ANN function may perform more accurate classifications regarding the health state of the microalgae of the microscope image, thereby providing specific information for applying feedback actions based on the physiological states.

Now, the machine learning function computes a classification of the micro-organisms present in the microscope image according to a combination of taxonomical classification of the microalgae species and/or genera, of other micro-organisms and with respect to the physiological functioning of the microalgae. Therefore, the machine learning function trains the ANN function to classify the micro-organisms with respect to the functional aspects thereof, thereby providing qualitative assessments of the health of the culture in its medium. Indeed, the physiological functioning of the microalgae present in the microalgae culture sample may comprise the functioning of the individual microalgae with respect to its health and with respect to its interaction with other micro-organisms.

In examples, the predetermined set of microalgae physiological states includes one or more microalgae health states. By “health state” it is meant a predetermined piece of information related to the health of the microalgae present in the image of the corresponding culture sample. The one or more health states may be predetermined according to any given criteria for assessing the health of the microalgae present in the image of the corresponding the microalgae culture sample.

For example, the microalgae health states may comprise or consist of a (e.g. single) “healthy” or “normal” state (i.e., with good/normal physiological functioning in the microalgae culture sample) and a (e.g., single) “sick” state (i.e., with a decreased physiological functioning in the microalgae culture sample compared to a healthy microalgae). The (trained) ANN function thus correlates the health state of the microalgae with the geometric form or appearance. It has been identified that image-based machine-learning allows recognition and discrimination between such states.

The ANN function may be configured to compute a binary classification of the health of the microalgae present in the image of the corresponding microalgae culture sample.

Alternatively, the health states may comprise several sick or unhealthy states which may include a “cellular explosion” state, a “shape deformation” state, and/or a “color change” state. The ANN function is thus configured in such a case to compute pieces of information detailing the sickness of the microalgae present in the image with respect to explosion of the cellular walls of the microalgae (that is, there is a lack of content inside the cells), the deformation of the shape of the microalgae (e.g., lost flagella), and/or the change in color of the microalgae. Therefore, the ANN function classifies the micro-organisms according to structural damage such as explosion of the cellular walls of the microalgae, deformation of the shape of the microalgae and/or a change in color of the microalgae.

In examples, the predetermined set of microalgae physiological states (e.g., further) further includes an agglomeration state for the micro-organism, e.g., indicating that the micro-organism is agglomerated with other micro-organisms of the same species and/or genus. Alternatively or additionally, the predetermined set of microalgae physiological states may include a duplication state, e.g., indicating that the micro-organism in the microalgae culture sample is in a stage of its reproductive process. The ANN function is thus configured to compute pieces of information for each micro-organism of the image of the corresponding culture sample, indicating the sickness of the microalgae corresponding to the density of a group of a same species of micro-organisms in an area of culture sample (i.e., the agglomeration of the group) and/or the presence of duplicated microalgae. The ANN function thus classifies micro-organisms according to the density of a group of a same species of micro-organisms in an area of the microscope image (i.e., the agglomeration of the group) and/or the presence of duplicated microalgae. A high density of the group of a same species may be caused due to competition for resources in the microalgae culture sample, bioflocculation, i.e., stress on the microalgae, all indicative of bad health of microalgae. In addition, the presence of duplicated microalgae (or its lack thereof) indicates the health of the population. Indeed, a lack of reproducing microalgae indicates a bad health of microalgae present in the microalgae culture sample. It has been identified that image-based machine-learning allows recognition and discrimination of such states.

Referring back to FIG. 1, the machine-learning method comprises providing S110 a dataset comprising training patterns. As known per se from the field of machine-learning, the dataset impacts the speed of the learning of the ANN function and the quality of the learning, that is, the accuracy of the trained ANN function to analyze microscope images. The dataset may be provided with a total number of training patterns that depends on the contemplated quality of the learning. This number can be higher than 1 000, 10 000, or yet 100 000 training samples comprising the contemplated species of microalgae and/or biological attributes. The quantity of the data in the dataset follows a tradeoff between the accuracy to be achieved by the ANN function, and the speed of the training.

Each training pattern comprises a microscope image of a microalgae culture sample and a plurality of annotations. Each annotation is a piece of data that represents an instantiation of a biological attribute of micro-organisms present in the microscope image of the microalgae culture sample. Each annotation comprises a localization in the image containing at least one given micro-organism present in the microscope image of the microalgae culture sample. For example, an annotation may comprise or consist of a label affixed or associated to the localization of the at least one given micro-organism. Each annotation further comprises a value of the one or more biological attributes for the at least one given micro-organism. The one or more biological attributes may be from any of the predetermined set of categories for the at least one given micro-organism. For example, an annotation of a micro-organism may comprise values defining the localization in the image containing at least one given micro-organism, e.g., a bounding box represented by coordinates (x, y) and size specifications, such as width and height, and values of one or more biological attributes (e.g., including microalgae species and/or non-microalgae status, and physiological state if microalgae).

The dataset may be provided with a contemplated variety of training samples and annotations to achieve a desired accuracy of the training. For example, the dataset may comprise at least 100 training samples of each category among the predetermined set including the plurality of microalgae species and/or genera. For example, the dataset may comprise at least 200 training samples for each category, wherein, e.g., 80% of the total training samples are used for training and the remaining 20% are used for hypothesis testing.

The machine-learning method then comprises training S120 the ANN function based on the provided dataset. That is to say, the (untrained) weights of the artificial neurons and the connections linking each of them, among the connected neural networks composing the ANN function are adjusted via the training. The ANN function is configured for processing an input microscope image of a microalgae culture sample.

For example, the ANN function may be denoted by a mathematical notation ƒ(I) where the argument I is an image of the dataset. The ANN function may comprise one or more neural networks and/or one or more deterministic function, each being connected among each other via any connection topology, e.g., some neural networks connected in series or parallel or other combinations thereof, e.g., so as to be represented by k functions such that ƒ(I)=ƒ_{K}(ƒₖ₋₁( . . . ƒ₁(I))).

As known per se from machine-learning, the training proceeds to adjust the weights of the untrained neural networks of the ANN function according to the computed output. As known per se, the output is compared to the values of the annotations in the training samples and the weights may be adjusted according to such comparison, for example via optimization of a loss, e.g., by using the gradient descent algorithm. The performance of the accuracy due to learning may be tracked using standard machine-learning methods.

The ANN function may comprise several neural networks. Optionally, in such a case, each neural network may be trained separately, thus performing for each network a distinct optimization of a respective loss to set the respective weights of the network. Alternatively, the networks may be trained together within a same optimization.

The machine-learning method forms an improved solution for analyzing microscope images of a microalgae culture sample. Indeed, an ANN function trained according to the machine-learning method is configured for processing an input image of a microalgae culture sample and outputting information on biological attributes at each localization of the at least one respective micro-organism that allows to make qualitative assessments on the health of the population of the microalgae culture sample. Notably, the processing performed by the trained ANN function is particularly fast, compared to a manual assessment of microalgae health by using prior art methods for detecting microalgae populations, such as high-throughput sequencing methods or qPCR. Said methods may take up-to several months for obtaining results. In contrast, the ANN function trained according to the machine-learning method may process the image of the microalgae in a much fastertime, e.g., in a matter of minutes.

This in turn yields an improvement of industrial bioreactor system processes such as processes for biodiesel production. Thanks to the incorporation of the image-analyzing method, based on the machine-learning method, into a bioreactor maintenance process. The image-analyzing method achieves an automated detection of biological attributes that allow to perform quantitative assessments of the health of the microalgae in the bioreactor. Environmental or internal conditions affecting the health of the microalgae in a bioreactor system may occur in a matter of few days (e.g., a fortnight), even few hours. An ANN function trained according to the method allows to obtain results in a shorter time span (e.g., in the order of minutes). Thus, corrective actions on the bioreactor may be performed in a short time span following an assessment of the bad health of the microalgae populating the bioreactor, thereby improving the maintenance.

In examples, the providing of each microscope image at S110, S220, and/or S310 may comprise capturing the microscope image the captured microscope image. The microscope image may be captured with a camera integrating a microscope or associated to a microscope, where the camera is configured for that purpose, e.g., configured with an exposure time, area to be photographed and/or pixel resolution specially adapted for capturing the microscope image under standard laboratory conditions.

In examples, the ANN function may comprise a pre-processing. By “pre-processing” it is meant any sub-function that processes an input microscope image after it is captured and outputs an intermediate result inputted to one or more other sub-functions/processes before yielding the output of the ANN function (i.e., value of the one or more biological attributes). The intermediate result is an image different from the input image, and not yet containing the output of the ANN function. The pre-processing may thus be part of an initial operation performed by the ANN function when used online (i.e., during the image-analyzing method), or part of a preparation of the dataset performed before the training, either before or after the annotation, when offline (i.e., during the machine-learning method). The pre-processing may be deterministic. Alternatively, the pre-processing may comprise one or more pre-trained neural networks.

The pre-processing may comprise or consist of one or both of a (e.g., deterministic) color balancing of the image and a (e.g., deterministic) contrast enhancement. It has been identified that such specific pre-processing improves recognition of microalgae species, distinction between microalgae and non-algae algae micro-organisms, and recognition of microalgae physiological states.

By “color balancing”, it is meant any method of image processing that adjusts the intensities of the colors of the image, e.g., on the color components of an RGB image. The scaling of the colors may be performed by any method, e.g., including scaling camera RGB or Von Kries's method. This allows normalization of the colors of the image, so as to reduce noise or bias introduced by the type of microscope. That is, color balancing promotes the reproducibility of the images by rebalancing the biases induced by the camera sensor, by homogenizing the images from different devices (microscopes, cameras), and compensates for variations in the light source (LED, halogen lamp, etc.).

By “contrast enhancement” it is meant any method of image processing for modifying the contrast of an image defined via any known formula such as Weber contrast, Michelson contrast or RMS contrast. The contrast enhancement may obtain the maximum intensity and the minimum intensity of the image to improve the observation of cells. Indeed, it has been noticed that, setting as hypothesis that the background of the microscope images must be white, the algae may be taken as the most opaque objects and thus contrast enhancement allows for a better distinction. It has been noticed that this hypothesis provides best results, as the samples may be taken in natural light whereas, for example in polarized light it is different. It is thus estimated that the water should be transparent/white so that the contrast enhancement provides best results.

The pre-processing may thus improve luminance, color and brightness of the elements of the microscopic image, notably, of micro-organisms present in the image. Indeed, the pre-processing may form a calibration configured to enhance the distinguishability of the micro-organisms with respect to the background image, which corresponds usually to the aqueous media where the microalgae culture is placed. The calibration improves the recognition of the green Chlorophyll in the center of the observed microalgae cells, enhancing the shape and structure recognition of the microalgae. The pre-processing may as well enhance the colors of other micro-organisms, such as non-algae microorganisms. Thus, the pre-processing may also improve identification thereof, and the ANN function is more accurate for classifying the micro-organisms irrespective of light quality.

The ANN function may be configured for determination of the plurality of localizations (e.g., bounding boxes). The determination of the plurality of localizations may thus be part of an initial operation performed by the ANN function when used online. In such a case, the determination of the plurality of localizations may be part of a preparation of the dataset performed before the offline training. For example, the determination of the plurality of localizations in the preparation of the dataset may be performed (e.g., manually) upon annotation.

The determination of the plurality of localizations may be deterministic. In such a case, the determination of the plurality of localizations may be performed offline before the annotation, so as to facilitate annotation. Alternatively, the determination of the plurality of localizations may be performed by one or more neural networks. In such a case, said one or more neural networks configured for the determination of the plurality of localizations may be either pre-trained or trained during the machine-learning method.

In examples, the ANN function may comprise a (e.g., deterministic) region of interest algorithm configured for such determination of the plurality of localizations (e.g., bounding boxes). The region of interest algorithm is an algorithm of image processing configured to receive as input a microscope image and to output a set of one or more closed curves, e.g., bounding boxes, that each enclose a region in the image (i.e., an area of pixels of the image) each containing at least one respective micro-organism.

In examples, the region of interest algorithm comprises, for an input microscope image, applying a low pass filter that outputs a binary image. Pixels of the binary image having value 0 may correspond to pixels of the background and pixels of the binary image having value 1 may correspond to a pixel of each microalgae of the culture.

The low-pass filter may output pixels of the binary image according to a (e.g., predetermined) cut-off frequency. For example, pixels with frequency below the cut-off frequency of the low pass filter correspond to pixels in the background and thus having value 0 and pixels above the cut-off frequency of the low pass filter correspond to pixels of (identified) micro-organisms of the culture (microalgae and non-algae micro-organisms), and thus having value 1. The cut-off frequency may be set in any manner.

The region of interest algorithm may further comprise, detecting connected components in the binary image. By “connected components” it is meant any group of pixels in the image that have the same property (e.g., same value) and which are connected with each other by one single continuous pixel path for each pair of the group. The region of interest algorithm may index the detected connected components.

The region of interest algorithm may yet further comprise determining, for each connected component, a bounding box. The bounding box may be determined by framing the detected connected components. For example, the region of interest algorithm may add a margin at the top, bottom, left and right, and determine a (minimal size) bounding box that encloses the detected components with the margin. In examples, the region of interest algorithm may output a data structure comprising a list of tuples with four values of the determined bounding boxes, e.g., (x position in the image of the top left corner, y position in the image of the top left corner, width of the box, height of the box).

The region of interest algorithm may be a deterministic algorithm, as the low pass filter may be directly applied. Thus, regions of interest are found in an self-adaptive manner and without supervised learning. It is not required to preconfigure the deterministic region of interest algorithm, such that the ANN function can locate various objects (microalgae) with great precision, thanks to microscope images of culture samples presenting a relatively uniform image background. The region of interest algorithm may provide thousands of objects (e.g., more than three thousand) of interest for each image, as the culture sample comprises thousands of microorganisms.

In other examples, the ANN function may comprise a non-deterministic function configured for determination of the plurality of localizations, for example a neural network such as an object detection neural network. An object detection neural network improves detection thanks to the context, and distinction between duplication and agglomeration. Indeed, an object detection neural network allows context-based learning.

The ANN function may comprise one or more neural network classifiers. By “neural network classifier”, it is meant a single neural network configured to take as input an image and to output information that assigns to at least part of the input image a piece of information indicative of one class among a predetermined set of classes, for example a label among a set of labels each corresponding to a respective one of the predetermined set of classes. By “single” neural network, it is meant as well-known from the field of machine-learning that a classifier is fully trained in a single training process, by minimizing a single loss involving all the classes of the predetermined set of classes. A single classifier corresponding to a predetermined set of classes is thus different from a series of classifiers which altogether achieve a classification among the same predetermined set of classes.

The one or more neural network classifiers may receive as input with the microscope image (e.g., the raw microscope image after application of the pre-processing sub-function), or alternatively extracts (e.g., portions) from the microscope image (e.g., from the raw microscope image after application of the pre-processing sub-function). In particular, the ANN function may comprise a sub-function configured for determination of the localizations (e.g., bounding boxes), and the one or more neural network classifiers may be provided with extracts each of a respective determined localization (e.g., content of a respective bounding box). The one or more neural network classifiers may thus process each extract independently (e.g., sequentially or in parallel). Alternatively, the one or more neural network classifiers may comprise an object detection neural network classifier (e.g., initial classifier, i.e., applied before any other classifier of the ANN function) that is configured to both classify objects and determine localizations thereof. In such a case, the object detection classifier is provided with the whole microscope image (e.g., the raw microscope image in full after application of the pre-processing sub-function), and only optional subsequent neural network(s) may be provided with extracts each of a respective determined localization (e.g., content of a respective bounding box).

The ANN function may comprise a binary classifier (e.g., initial classifier). The binary classifier may thus classify elements in the image in a set of two groups on the basis of a classification rule. For example, the classification rule may be, for each respective localization, to determine whether the at least one respective micro-organism is a microalgae or a non-algae micro-organism. Thus, the binary classifier may provide a simple rule for discriminating microalgae from other (i.e., non-algae) micro-organisms. The binary classifier may optionally be an object detection classifier.

The ANN function may further comprise a multi-class classifier. The multi-class classifier is an artificial neural network that classifies objects in an input image according to a predetermined set of classes. The multi-class classifier may be configured to determine at least partly the value of the one or more biological attributes for microalgae contained in localizations of the image that the binary classifier has identified to contain microalgae. Such a sequential approach between a binary classifier and a multi-class classifier improves efficiency, as each classifier may specialize appropriately to respectively distinguish algae and non-algae, and different classes of algae.

The multi-class classifier may be configured, for each respective localization containing a microalgae micro-organism, to determine a respective class from a predetermined set of classes comprising combinations of both a microalgae species or genus and a physiological state. In other words, at least part of the classes of the single multi-class classifier combine information both on species/genus and physiological state (rather than using a neural network for species/genus classification and a separate neural network for physiological state classification.

It has been identified that combining categorization among a plurality of microalgae species and identification among microalgae physiological states improves both individual aspects in a machine-learning framework. In other words, by annotating the dataset not only with species information but also with physiological information, the ANN function can look at the same time at both pieces of information combined together and recognize at once both the species and the physiological state more accurately than if looking at each piece of information individually and having to recognize each attribute successively. This is due to the physiological state of a microalgae species having a significant impact on its visual aspect, thus on an image-based analysis thereof. In other words, the multi-class classifier mutualizes information that combined tell more than if looked at separately.

The binary classifier and/or the multi-class classifier may present the architecture for example of any state-of-the-art classification neural network, such as InceptionV3, ResNet50 or GoogleNet. In case the binary classifier performs object detection, the binary classifier may alternatively present the architecture of YoloV5.

A microscope image of a microalgae culture sample may contain thousands of microorganisms (i.e., hectares of culture), which makes visual evaluation of the sample impractical. The ANN function allows to obtain the health state among the thousands of microorganisms, thanks to the training.

Now, the image analyzing method may be applied to the acquired microscope images of microalgae culture samples. The microscope image may have been acquired from photo shots, by a microscope, over a thin slide where it is placed a drop sample from the bioreactor.

Then, for example, the analysis of the input microscope images is the result of five steps:
(Step 1) Applying first the color balancing algorithm to the input microscope image. The color balance algorithm outputs a resulting image that balances the amount of blue, red and green in the microscope image.
(Step 2) Applying the contrast enhancement algorithm. Although at the end of step 1 the amount of color is well balanced, they may all be too dark or all too light. Step 2 outputs a resulting image that adjusts the brightness of the resulting image of Step 1.
(Step 3) Applying the Region Of Interest (ROI) algorithm. The algorithm of Step 3 outputs, from the resulting image of Step 2, a resulting image which takes the form of a rather uniform background (low 2D frequency) and from 0 to several objects (varied frequency range). The ROI algorithm may consist of the following sequential steps:
   i. (Step 3.1) A low pass filter, that makes it possible to detect the background. Pixels of microalgae are obtained based on the contrast levels. The low pass filter outputs a binary image 0 for the background pixels and 1 for the object pixels.
   ii. (Step 3.2) A connected component detection algorithm applied to the output of the low pass filter associates an identifier to each region of interest.
   iii. (Step 3.3) A “bounding box” algorithm that returns, for each connected component, the coordinates of a box enclosing the connected component. The box may be defined in terms of its center coordinates in the image and its dimensions, that is a quadruplet {x coordinates, y coordinates, width, height}. The algorithm outputs a list of quadruplets.

The preprocessed image from steps 1 and 2 and the list of quadruplets obtained in step 3 are then input to the one or more neural networks of the ANN function. The ANN function comprises a binary classifier and a multi-class classifier.

The ANN function may process the pre-processed image and the list of quadruplets as follows:
(Step 4) The preprocessed image and the list of quadruplets are input to the binary classifier. The binary classifier distinguishes, for each region of interest surrounded by a bounding box, a microalgae from other objects (bacteria). In other words, the binary classifier is applied separately to each extract from the preprocessed image corresponding to the portion of the image inside a respective bounding box.
(Step 5) For each region of interest marked by the binary classifier as containing a microalgae, the region of interest is input to the other classifier network (multi-class classifier) that distinguishes the microalgae among the plurality of microalgae species and/or general, and also identifies a physiological state.

The pre-processing of steps 1 and 2 and the region of interest algorithm of step 3 may be deterministic algorithms. Thus, the image analyzing method obtains quickly the information on the microalgae, as the steps 1 to 3 are performed on the fly without further configuration. The image analyzing method thus automates microscope image capture and enhances the images with the information on the health of each algae on each bounding box. This is all thanks to the application of the machine-learning paradigm to perform the automation. Moreover, the image-analyzing method is non-invasive and non-disruptive. Indeed, the image-analyzing method only needs microscope images of microalgae culture samples, which may be obtained from a drop of the culture in a thin slide. In addition, thanks to the fact that the image-analyzing method only requires images, it is applicable to any type of basin and operation of different scales. It is applicable as well to laboratory, pilot or industrial bioreactors, whatever the volume of the bioreactor. Thanks to the added automatism, responsiveness is increased so as to adapt the operation of the culture to ensure optimal performance.

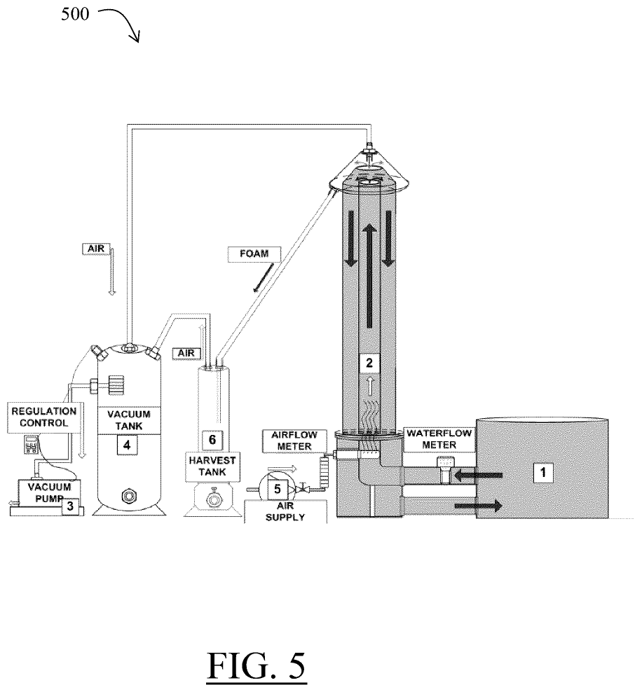

Further examples are discussed with reference to FIGS. 5 to 11, as well as experimental results obtained based on these examples.

FIG. 5 shows an example of a bioreactor 500 of the bioreactor maintenance process, used for performing algal culturing.

A pilot program has been conducted based on the architecture of bioreactor 500. Microalgae inoculum of Nannochloropsis oculata was obtained. The cultures are performed at atmospheric conditions (i.e. temperature, pressure, rain, solar radiation, etc.) in order to anticipate real conditions at industrial scale. The bioreactor comprises a raceway open pond of surface area of 9.62 m², a maximum water depth of 60 cm, a vacuum airlift column of 4.7 m of height and a harvesting tank having 100 L of volume. The pond allows a maximum water depth of 60 cm. The experiment uses a depth of 20 cm.

Culture medium in the pond is stirred thanks to the action of the vacuum column (−0.4 bar Prel. and 0.6 bar Pabs.) connected to a vacuum pump which allows an average circulation capacity in the pond of about 30 m3·h−1 for an average air flow injected by suction of about 15 m3·h−1 (maximum of 30 m3·h−1). Air is sparged into the culture via a microbubble diffusion system at the bottom of the column, by using an air compressor (2.2 kW-220 V). CO2 addition is regulated based on the pH level (pH set=8±0.5) of the ponds. CO2 is sparged into the culture via diffusion system at the bottom of the column, which is connected to CO2 gas bottles. Temperature in the pond is not regulated. The bioreactor is also equipped of a weather station in order to collect data of atmospheric parameters (P, T, light intensity, rain, etc.). A sliding roof is installed over the pond to prevent from rain and limit contamination as well as maintaining a constant volume in the pond, by minimizing evaporation.

It was inoculated into the pond a volume of 6.3 L of Nannochloropsis oculata at an initial total suspended solid (TSS) concentration of 41 g·L−1 in a working volume of 2.5 m3, i.e., water depth of 20 cm under circulation conditions. The inoculation was performed at ambient temperature and light irradiance, in a simulated marine environment using F medium diluted with artificial seawater to reach a salinity concentration of about 50 g·L−1. The initial optical density (OD) at 680 nm was 0.6, corresponding to a theoretical TSS concentration of the inoculum in the pond of 0.1 g·L−1 The flow rate of 10 m3·h−1 in the raceway corresponds to a superficial flow velocity of 0.17±0.01 m·s−1). pH was maintained at 8±0.5, thanks to the CO2 addition. A volume of microalgae culture was replaced every day by the same volume of water, salts and nutrients (NaNO3 and NaH2PO4-H2O) to maintain the initial concentration of F medium and salinity. Every two weeks, oligo-elements and vitamins were added to maintain the initial concentration of F medium. This mode of culture was used to maintain a constant concentration of microalgae in the raceway (0.19±0.02 g·L−1 of theoretical TSS).

It is now described an overview of an example of the acquisition of microalgae culture samples, the acquisition of microscope images, and the pre-processing thereof, to provide the dataset of training patterns. The experimental results correspond to tests conducted based on this example.

### Preparation of Samples and Image Acquisition.

Five different samples from monospecific microalgae cultures were collected: Chlorella vulgaris, Dunaliella salina, Nannochloropsis oculata, Tetraselmis suecica, Nannochloropsis sp.+Tetraselmis sp.

One drop per sample is placed on a thin microscope slide. The microscope slide has dimensions 75×25 mm. Then, a coverslip is sealed over the slide with nail varnish. The nail varnish prevents the flow of fluid and immobilizes the coverslip. A duplicate containing D. salina was treated with Lugol to immobilize the cells.

A first set of images was acquired to test classification of algae by examples of the ANN function.

The images are acquired with a motorized microscope Leica DM6000B equipped with a color camera of 4 Mp 14-bit. Sensor resolution was of 7.4 μm. The system is controlled by an application used to configure a field of view to be photographed without human intervention. The images are taken without filter in bright field with 63× magnification (oil immersion) and a 1.2× adapter which avoids the vignetting effect of the camera. The scale is 0.098 μm/pixel. It is shot, for each field of view, a stack of images with resolution of 2048×2048 pixels. An algorithm saves the sharpest image. The exposure time is calibrated to 5 ms in order to have a homogeneous distribution of the histogram of pixel color values centered on 14-bits/2, which corresponds to the value of the background of the fields of view. The image acquisition procedure takes between 245 and 431 fields of view per sample depending on cell density.

It is now described an example of image pre-processing for the acquired images.

Each acquired image I comprises three color channels: red (Iᵣ matrix), blue (I_{b} matrix) and green (I_{g} matrix). Each image is thus a grid of dimension 2048×2048×3 (pixel width×pixel height×color channels). Each of the intensities is coded on 1 byte, and therefore between 0 and 255, as usual in imaging. For example, a black pixel is represented with the values (0,0,0) the white (255,255,255) the primary red (255,0,0) or the like. In the following, the notation I[i, j] is used for denoting the pixel value of image I at position [i, j].

The image pre-processing comprises two stages: contrast enhancement and color balancing. The image pre-processing is followed by a deterministic object detection.

### Contrast Enhancement.

The contrast enhancement method comprises two steps.

Step 1) The image I is converted into a black and white image by averaging the three channels I_{wb}=(Iᵣ+I_{g}+I_{b})/3. Light intensity is computed from each pixel of the black and white image I_{wb}. It is captured the maximum and minimum intensity information of the image I_{wb}, denoted pₘₐₓ and pₘᵢₙ respectively.

Step 2) The formula for contrast enhancement of the colored image is

$${I}^{′} = 255 * \frac{I - {p}_{min}}{( {p}_{max} - {p}_{min} )} .$$

Thus, I′ is the contrast corrected image. Thanks to this formula, the amplitude of the 255 possible values allowed by the bytes will be correctly used.

### Color Balancing.

The color balancing comprises three steps.

Step 1) It is calculated a mean pixel value p for each pixel of the image. Since the images are RGB images, the mean pixel value p contains three values, representing the average of the red channel pᵣ, green channel p_{g} and blue channel p_{b}.

Step 2) The largest value among pᵣ p_{g} and pₘₐₓ is named pₘₐₓ.

Step 3) The tint of the image channel by channel is corrected as per the following formulae:

I′ᵣ=Iᵣ*(pₘₐₓ/pᵣ);

I′_{g}=I_{g}*(pₘₐₓ/p_{g});

I′_{b}−I_{b}*(pₘₐₓ/p_{b}).

If the pixel value is recalculated (as in step 1) but for the contrast enhanced image I′, then it is obtained p′ᵣ=p′ g=p′b. In other words the colors are well balanced. If the background is gray and the background pixels are an overwhelming majority, then the objects will have their natural color.

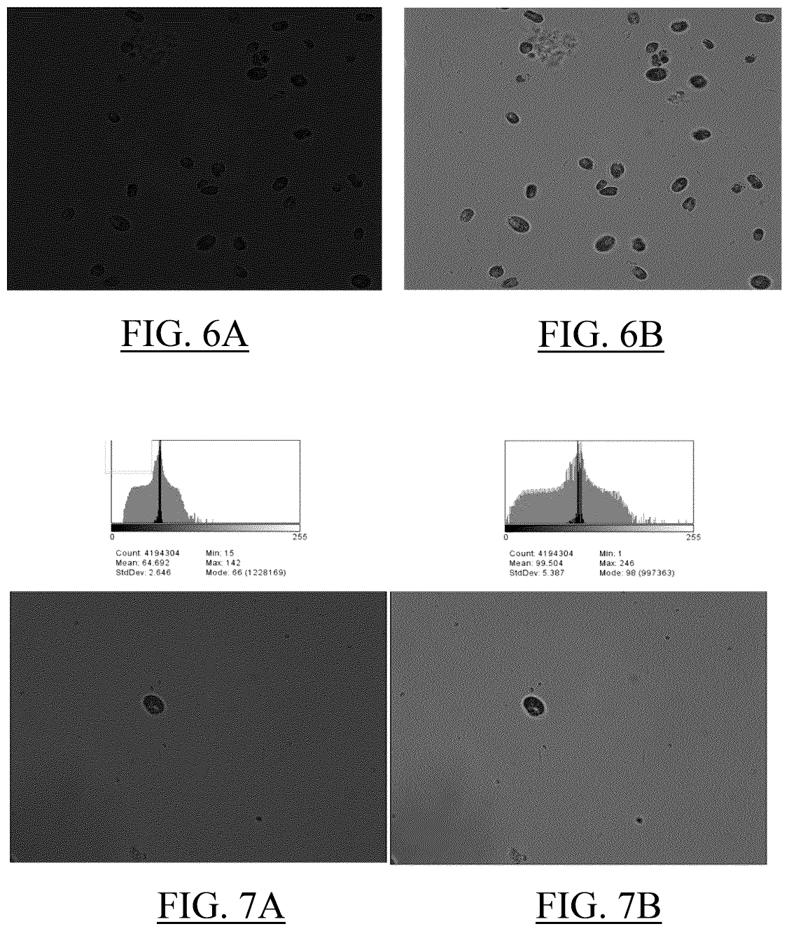

FIG. 6A shows a microscope image of a sample of microalgae of the genera Tetraselmis. FIG. 6B shows the result of applying the pre-processing.

FIGS. 7A-7B illustrate more specifically contrast enhancement, and they show an intermediate result showing the change in contrast of the image. FIG. 7A shows a histogram in the distribution of light intensity, and FIG. 7B shows a corresponding distribution after contrast enhancement. The change in distribution improves the visual distinction of the microalgae with respect to the background.

### Object Detection

The object detection method is a deterministic region of interest algorithm which takes as input RGB image I of size 2048×2048 αnd outputs a mask of size 2048×2048 which for each pixel indicates whether it belongs to an object (with value “1”) or not (with value 1101).

The method is based on a Truncated Fourier Transform. Low frequency pixels. Coefficients are complex numbers with a real and an imaginary part.

The object detection comprises seven steps.

Step 1) Image I is converted to black and white, to the Truncated Fourier Transform method is used in the same manner as if working on 1D or 2D signal, instead of working with a more complicated colored image.

Step 2) Fourier coefficients are computed from the converted image, ending up with a 2048×2048 matrix with a complex coefficients. For example, a complex coefficient is of type 1+2i (the real part is worth 1 and the imaginary part is worth 2i). The matrix is denoted as C. By convention, the lowest frequency is stored in the center of the matrix. That is, it is the value C[1024,1024].

Step 3) The 9 low frequency coefficients are cancelled, by changing the corresponding matrix values of C to the value 0+0i. In other words C[1024,1024]=0+Oi as well as the 8 neighboring values.

Step 4) The Inverse Fourier Transform is computed from the new matrix C obtained after step 3. This is an image whose low frequencies have been canceled. The result of the Inverse Fourier Transform is denoted I₂.

Steps 2 to four 4 may also be called a “High-pass filter” of the image.

Step 5) The mask is now computed. It is a matrix denoted as B and of dimensions 2048×2048. B contains a 1 if it's an object and 0 if it's background. All the values of the matrix I₂ having values 0 or 1 are considered background, as these correspond to values of low frequency.

The mask B is computed from 1₂ according to the following formulae:
B[i,j]=1 if I₂[i,j]>1;
B[i,j]=0 otherwise.

Step 6) Next, it is calculated a matrix of connected components of the mask B as a matrix 0 of dimension 2048×2048. Connected components are identified in 0 with an index from 1 to n. The value 0 also encodes the background in 0.

Step 7) It is computed a list of bounding boxes using 0 so that each connected component is framed. A margin of 3 pixels is added at the top/bottom and left/right of each connected component.

The data structure at the output of step 7 is therefore a list of tuples with 4 values (x position of the top left corner, y position of the top left corner, width of the box, height of the box).

The pre-processing and object detection are applied to all of the captured images. Next, annotations are determined for each detected object. The annotations may be performed with state-of-the-art tools.

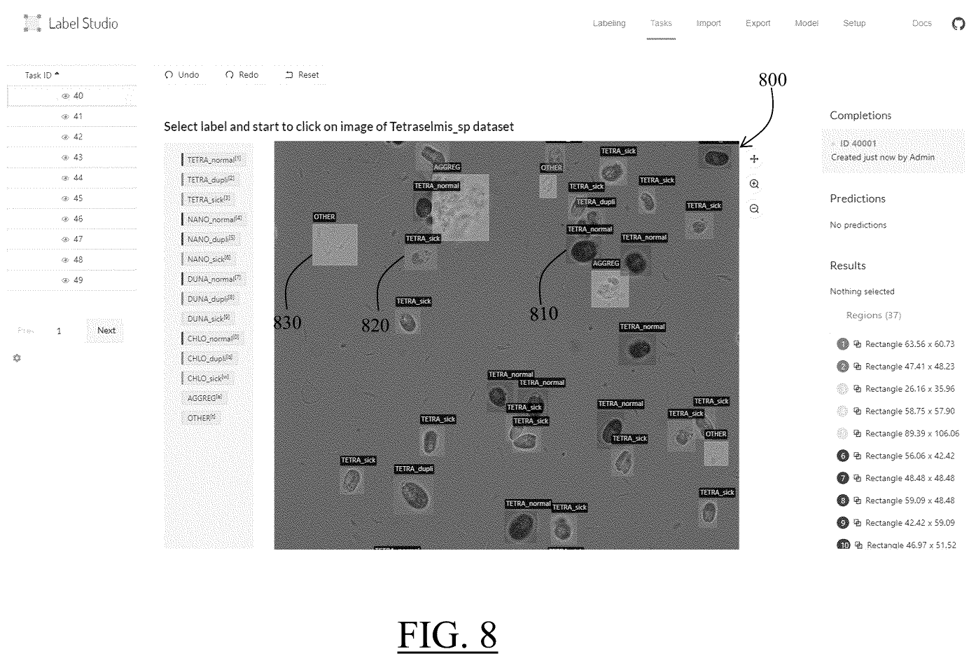

FIG. 8 shows an example of annotating a training sample, comprising a microscope image 800 of a culture composed of several micro-organisms of the genera Tetraselmis.

The image 800 is annotated at each organism enclosed by a bounding box. For example, micro-organisms having an interior being clearly defined over the contrast, and having a regular shape, correspond to healthy algae, e.g., the micro-organism in bounding box 810, which is labelled accordingly as “TETRA_normal”. For example, a micro-organism as in bounding box 820 with a collapsed interior is labelled as “TETRA_sick”. Non-algae micro-organisms as in bounding box 830 may be labeled as “OTHER”.

The experiment was realized on a dataset of 40 images, each comprising between three thousand and four thousand regions of interest.

Aspects of the machine-learning method are now described.

### Artificial Neural Network Function.

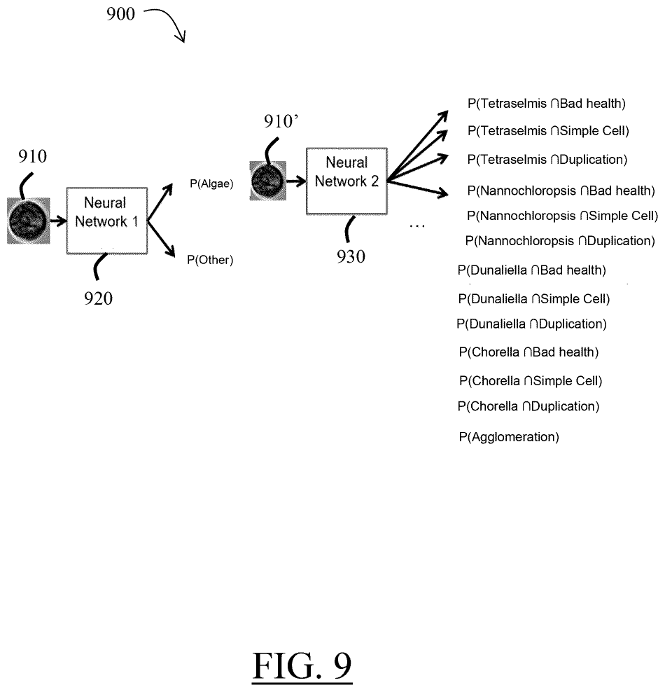

FIG. 9 shows an example of a part 900 of the ANN function used for analyzing microscope images of microalgae culture samples.

Illustrated on the figure are one or more networks of the ANN function including a binary classifier 920 and a multi-class classifier 930.

Binary classifier 920 receives as inputs extracts 910 of the pre-processed images consisting of the content of each bounding box determined by the object detection (region of interest) algorithm. Binary classifier 920 outputs a binary label indicating whether the micro-organism(s) contained in extract 910 is a micro-alga or not. This is performed for all extracts 910 stemming from the pre-processing and object detection applied to an acquired image.

Multi-class classifier 930 receives as inputs only the extracts 910′ determined by binary classifier 920 to contain micro-algae. For the localizations corresponding to the other extracts 910, the ANN function may provide as a final output the label “Other”, that is, the output of the binary classifier 920, thus indicating that the localization contains a non-alga micro-organism without further detail.

As can be seen from the example, multi-class classifier 930 is configured to output a label indicating a respective class from a predetermined set of classes comprising combinations of both a microalgae species or genus and a physiological state. In the example, the predetermined set of classes consists exactly of all combinations between a plurality of genera Tetraselmis, Nannochloropsis, Dunaliella and Chorella, on the one hand, and physiological states “simple cell” (i.e., “normal” and healthy state), “duplication” (i.e., duplicating thus healthy state) and “bad health” (i.e., “sick” state), on the other hand, plus an additional “agglomeration” physiological state with no distinction between the genera present in the agglomeration. The multi-class classifier 930 is thus configured to output for each localization of the input image corresponding to an extract 910′ a label indicating both the genus (among those listed) and the physiological state (among those listed), recognition of the two pieces of information being learnt in a single training optimization

The neural network 920 may comprise, e.g., a convolutional neural network such as YoloV5. The neural network 930 may comprise, e.g., a convolutional neural network such as InceptionV3, ResNet50 or GoogleNet.

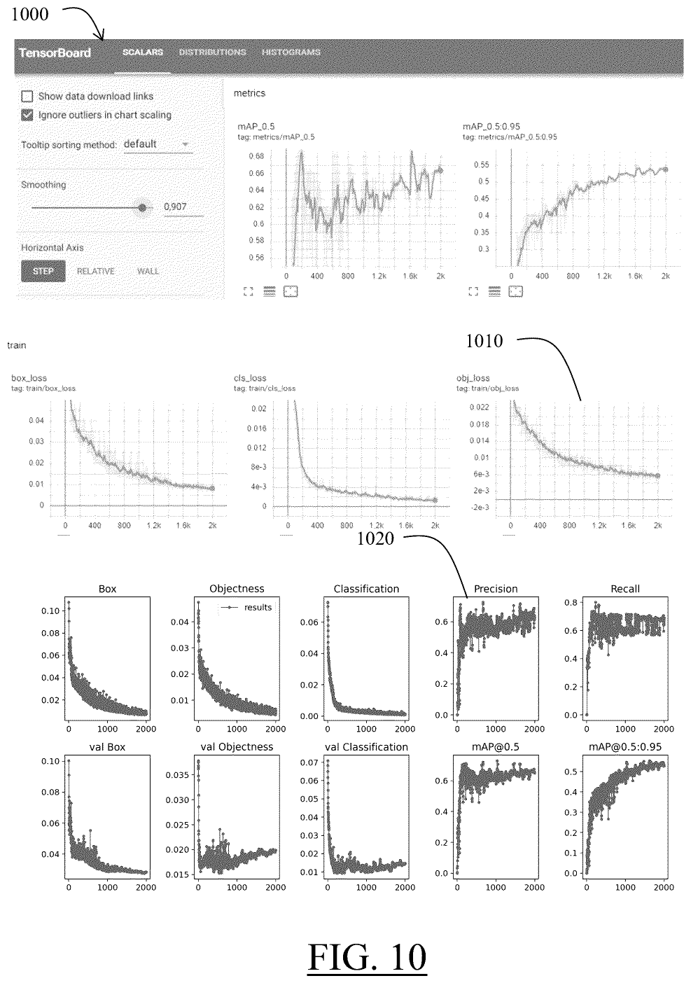

FIG. 10 shows performance metrics 1000 of the training according to the machine-learning method. The training of the ANN function was performed using high-performance computing structures and using Graphical Processing Units (GPUs) for optimizing performance. It has been noted that performing pre-processing provides a good trade-off between the accuracy of the classification. For instance, The figure shows a good trade-off between the precision of the ANN function 1020 and the overall time (in steps) needed to minimize the objective loss 1010, which was minimized with gradient descent.

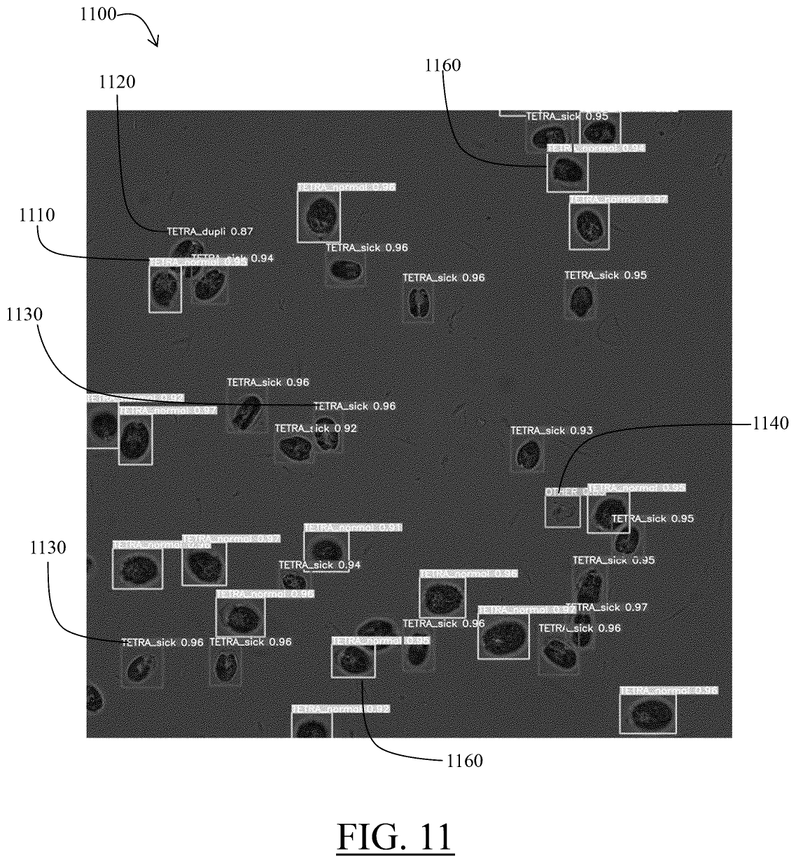

FIG. 11 shows the result 1100 of processing an input microscope image (such as the one of FIG. 6A) with the trained ANN function, wherein the input image is augmented with graphical representations of bounding boxes 1160 and associated labels 1110-1150 among the classes discussed with reference to FIG. 9.

In the illustrated example, the ANN function pre-processes the input microscope image to balance color and enhance contrast (such as illustrated on FIGS. 6-7). Then the ANN function applies a deterministic region of interest algorithm (such as discussed earlier) to determine and display on the image bounding boxes 1160 each containing an identified micro-organism(s). Finally, the ANN function applies one or more neural network classifiers (such as those of FIG. 9) to determine and display on the figure labels 1110-1140, optionally accompanied by a confidence score (as illustrated) at the position of each bounding box 1160.

In the illustrated example of FIG. 11, the microalgae culture sample was one of genus Tetraselmis. Labels 1110 indicate presence of “simple cells” of genus Tetraselmis which are healthy. Labels 1120 indicate presence of cells of genus Tetraselmis that are duplicating, thus considered healthy. Labels 1130 indicate presence of cells of genus Tetraselmis that are sick. Labels 1140 indicate contamination by non-algae organisms, indistinctively marked as “Other”. The sparsity of labels 1140 and the absence of agglomeration may be interpreted as the contamination being low thus not indicative of an upcoming culture crash. Thus, the bioreactor may continue to be exploited as is. Alternatively, it may be considered that no risk should be taken and an action may be performed on the bioreactor, such as a (e.g., partial) replacement of the culture.

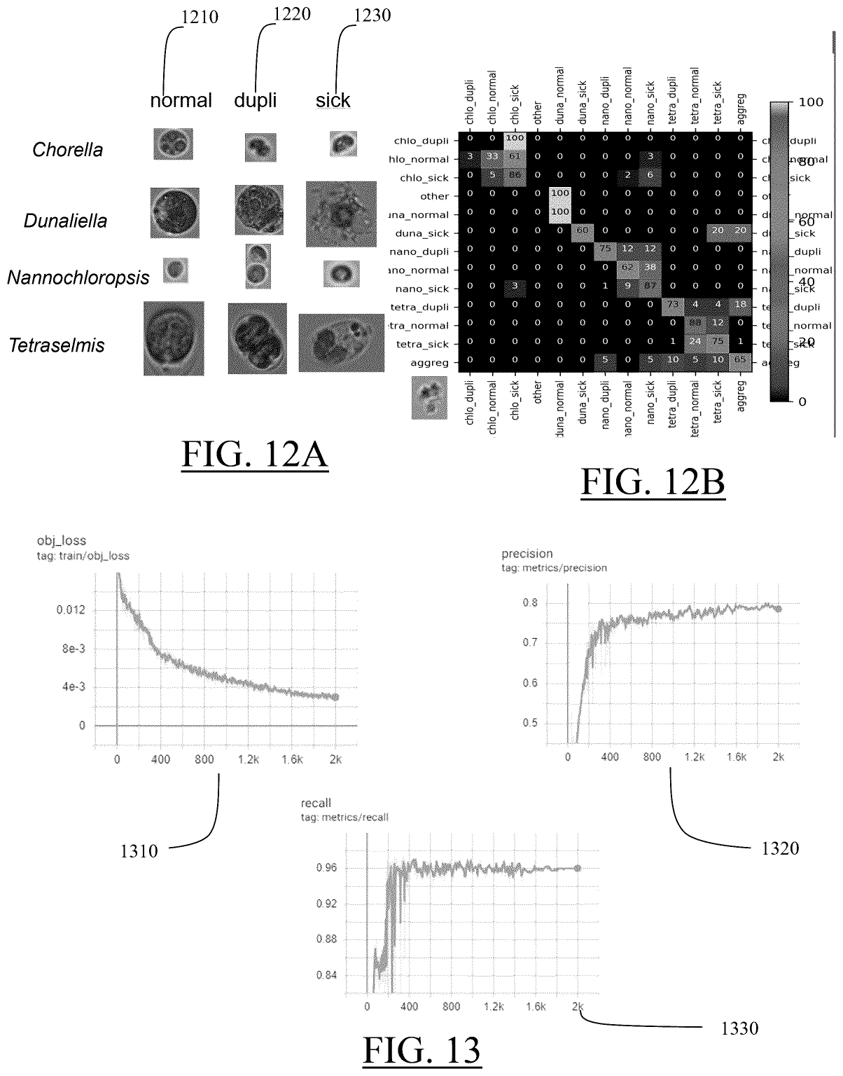

FIGS. 12A and 12B illustrate how the training is used to discriminate between a plurality of species of the genera Tetraselmis, Nannochloropsis, Dunaliella, and/or Chorella and under various physiological states. FIG. 12A shows an example table of bounding boxes of the microalgae images (output by the object detector) and its corresponding annotations. Each row corresponds to a respective genus of the microalgae of the bounding box, and each column corresponds to a respective annotation of the bounding box. Bounding boxes in column 1210 are labelled as “normal” (i.e., healthy). Bounding boxes in column 1220 consist of duplicated microalgae of each respective genus and are thus labelled as “dupli”. Bounding boxes in column 1230 consist of sick microalgae of each respective genus and are thus labelled as “sick”. FIG. 12B shows a confusion matrix which illustrates that the training of the ANN function looks for species information among the genera and physiological information at the same time. Each row of the confusion matrix corresponds to ground truth labeled data and each column corresponds to the predicted label. Each cell corresponds to the success rate of the training. The accuracy of the confusion matrix is reflected in that most of the high success rate cells (e.g., above 60%) are found on the diagonal of the confusion matrix.

Now, the ANN function may comprise an object detection neural network. FIG. 13 shows the performance of the training of the object detection neural network (YoloV5_x). The training of the ANN function comprising the object detection neural network thus takes advantage of the context to perform detection of objects of the input image and to perform, simultaneously, classification of the detected objects of the image. The performance metric 1310 shows the performance of the object localization over the training time (lower is better). The performance metric 1320 shows the confidence score of the precision of prediction (higher is better). The performance metric 1330 shows the recall, i.e., capacity to detect the classes (higher is better).

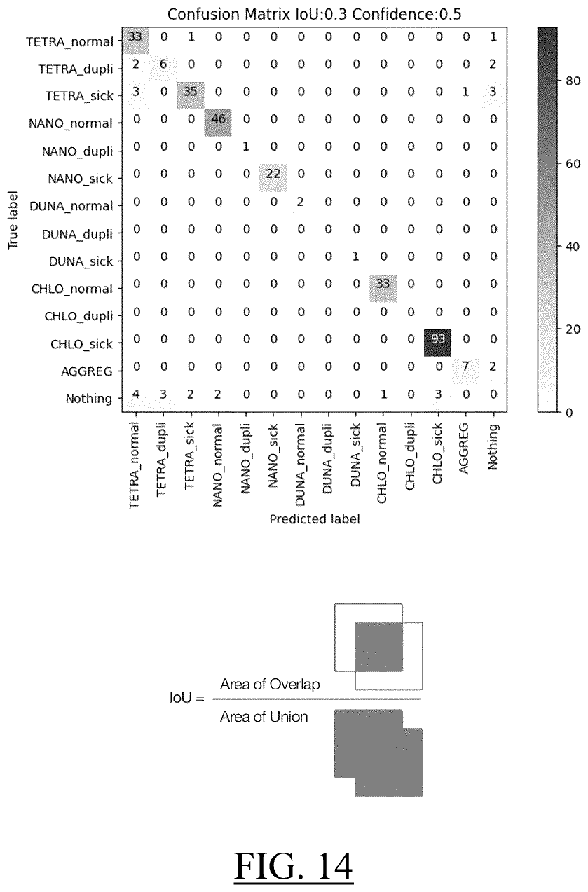

Now, the training may be modified to achieve a tradeoff between accuracy of the detected objects and simply counting the microorganisms of the image. FIG. 14 shows the confusion matrix of a matrix, wherein it is used an Intersection-Over-Union (IOU) constraint as a weak constraint. Here, the goal is on counting the microorganisms in the image, as such, the confusion matrix shows most of the predicted labels in the diagonal, although without a lower confidence.

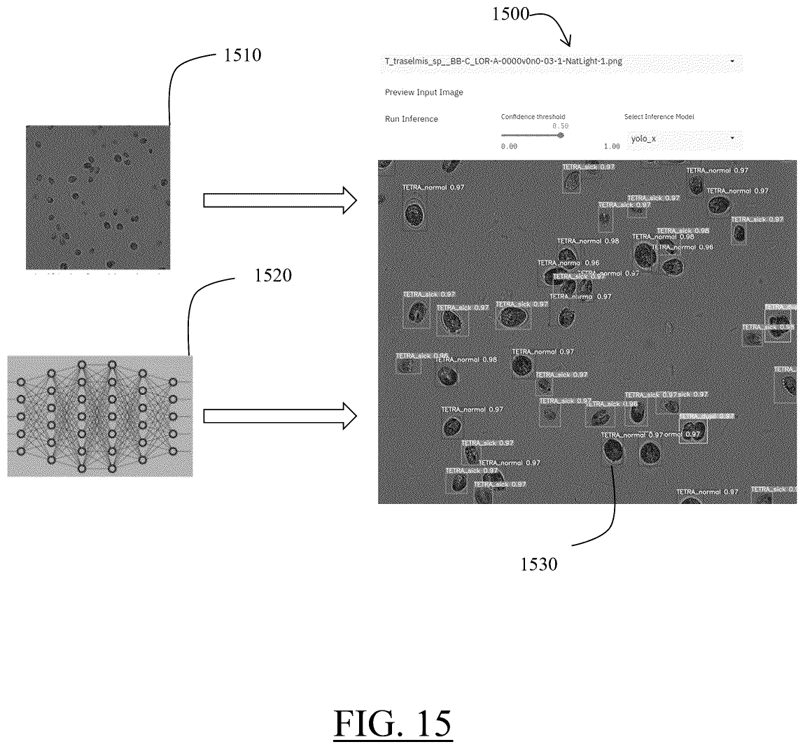

The ANN function may be integrated into an automatic detection application. FIG. 15 illustrates a web-based application 1500 incorporating the ANN function 1520. The utilization mode is simple. The user simply provides an input image 1510 and then run the inference in the GUI 1500. The GUI then shows the same input image with annotated bounding boxes, such as the box 1530 indicating a healthy microalgae of the genus Tetraselmis.

1. A computer-implemented method of machine-learning an artificial neural network (ANN) function configured for analyzing microscope images of microalgae culture samples with respect to one or more biological attributes, the one or more biological attributes comprising a category among a predetermined set of categories that includes a plurality of microalgae species and/or genera and at least one non-algae micro-organism category, the one or more biological attributes further comprising a physiological state among a predetermined set of microalgae physiological states, the method comprising:
providing a dataset comprising training patterns, each training pattern comprising a microscope image of a microalgae culture sample and a plurality of annotations, each annotation comprising a localization in the image containing at least one given micro-organism, each annotation further comprising a value of the one or more biological attributes for the at least one given micro-organism; and
training an artificial neural network function based on the provided dataset, the artificial neural network function being configured for processing an input microscope image of a microalgae culture sample and computing, for each respective localization among a plurality of localizations in the image each containing at least one respective micro-organism, a respective output representing a value of the one or more biological attributes for the at least one respective micro-organism.

2. The method of claim 1, wherein the predetermined set of microalgae physiological states includes one or more microalgae health states.

3. The method of claim 1, wherein the predetermined set of microalgae physiological states includes an agglomeration state and/or a duplication state.

4. The method of claim 1, wherein the plurality of microalgae species and/or genera includes one or more species and/or genera from the following families: Chlorophyceae, Xanthophyceae, Chrysophyceae, Bacillariophyceae, Cryptophyceae, Dinophyceae, Chloromonadineae, Euglenineae, Phaeophyceae, Rhodophyceae, and/or Cyanophyceae.

5. The method of claim 1, wherein providing of the dataset comprises, for each training pattern:
capturing the microscope image; and
pre-processing the captured microscope image by one or both of a color balancing of the image and a contrast enhancement.

6. The method of claim 1, wherein the providing of the dataset comprises, for each training pattern, determining the localizations of the annotations deterministically using a region of interest algorithm.

7. The method of claim 6, wherein the region of interest algorithm comprises for the microscope image of each training pattern:
applying a low pass filter that outputs a binary image, wherein pixels of the binary image having value 0 correspond to pixels of the background and pixels of the binary image having value 1 correspond to a pixel of each microalgae of the culture;
detecting connected components in the binary image; and
for each connected component, determining a bounding box.

8. The method of claim 1, wherein the artificial neural network function comprises a binary classifier configured, for each respective localization, to determine whether the at least one respective micro-organism is a microalgae or a non-algae micro-organism.

9. The method of claim 8, wherein the artificial neural network function comprises a multi-class classifier configured, for each respective localization containing a microalgae micro-organism, to determine a respective class from a predetermined set of classes comprising combinations of both a microalgae species or genus and a physiological state.

10. The method of claim 1, wherein the artificial neural network function comprises a pre-processing which includes one or both of a color balancing of the image and a contrast enhancement.

11. The method of claim 1, wherein the artificial neural network function comprises a deterministic sub-function configured for determination of the plurality of localizations using a region of interest detection algorithm.

12. The method of claim 11, wherein the region of interest algorithm comprises for the input microscope image:
applying a low pass filter that outputs a binary image, wherein pixels of the binary image having value 0 correspond to pixels of the background and pixels of the binary image having value 1 correspond to pixels of microalgae and non-algae micro-organisms of the culture;
detecting connected components in the binary image; and
for each connected component, determining a bounding box.

13. The method of claim 1, wherein the artificial neural network function comprises an object detection neural network configured for determination of the plurality of localizations.

14. A computer-implemented method for analyzing a microscope image of a microalgae culture sample, the image-analyzing method comprising:
providing an artificial neural network function trained to process an input microscope image of a microalgae culture sample and compute, for each respective localization among a plurality of localizations in the image each containing at least one respective micro-organism, a respective output representing a value of the one or more biological attributes for the at least one respective micro-organism; and
inputting to the artificial neural network function a microscope image of a microalgae culture sample to compute, for each respective localization among a plurality of localizations in the image each containing at least one respective micro-organism, a respective output representing a value of the one or more biological attributes for the at least one respective micro-organism.

15. A computer-implemented method for forming a dataset configured for machine-learning an artificial neural network function to process an input microscope image of a microalgae culture sample and compute, for each respective localization among a plurality of localizations in the image each containing at least one respective micro-organism, a respective output representing a value of the one or more biological attributes for the at least one respective micro-organism, the method comprising:
providing microscope images for each of a microalgae culture sample; and
for each microscope image, determining a plurality of annotations, each annotation comprising a localization in the image containing at least one given micro-organism, each annotation further comprising a value of the one or more biological attributes.

16. The dataset-forming method of claim 15, wherein the providing of the microscope images comprises, for each microscope image:
capturing the microscope image; and
pre-processing the captured microscope image by one or both of a color balancing of the image and a contrast enhancement.

17. The dataset-forming method of claim 15, wherein the determining of the plurality of annotations comprises, for each microscope image, determining the localizations of the annotations with a region of interest algorithm.

18. The dataset-forming method of claim 17, wherein the region of interest algorithm comprises for each microscope image:
applying a low pass filter that outputs a binary image, wherein pixels of the binary image having value 0 correspond to pixels of the background and pixels of the binary image having value 1 correspond to a pixel of each microalgae of the culture;
detecting connected components in the binary image; and
for each connected component, determining a bounding box.

19. A device comprising a computer-readable medium, the computer-readable medium comprising a data structure, the data structure comprising:
a neural network function trained to process an input microscope image of a microalgae culture sample and compute, for each respective localization among a plurality of localizations in the image each containing at least one respective micro-organism, a respective output representing a value of the one or more biological attributes for the at least one respective micro-organism.

20. (canceled)

21. The device of claim 19, wherein the device further comprises a processor coupled to the computer-readable medium.
